(19) United States
(12) Patent Application Publication
(10) Pub. No.: US 2018/0091036 A1
(43) Pub. Date: Mar. 29, 2018

(54) RIPPLE CURRENT REDUCTION SYSTEM

(71) Applicant: General Electric Company, Schenectady, NY (US)

(72) Inventors: Subhas Chandra DAS, Bangalore (IN); Ajith Kuttannair KUMAR, Erie, PA (US)

(21) Appl. No.: 15/279,460

(22) Filed: Sep. 29, 2016

(51) Int. Cl. H02M 1/14; H02M 7/44

(52) U.S. Cl. CPC H02M 1/14; H02M 7/44

(57) ABSTRACT

A ripple current control system includes plural inverters connected to a common bus. The inverters are configured to convert a direct current (DC) through the common bus to an alternating current (AC) by alternating different switches of the inverters between open and closed states in a switching cycle for each of the inverters. The system also includes a controller configured to reduce a ripple current conducted onto the common bus by controlling the inverters to apply a phase shift to the switching cycle of one or more of the inverters based on the number of the inverters.

### FIELD

Embodiments of the subject matter disclosed herein relate to electrical circuits, and to reducing ripple current on a bus of a circuit.

### BACKGROUND

A vehicle propulsion system may contain multiple traction inverters connected to the same direct current (DC) bus. Additionally, some powered systems may have multiple auxiliary load inverters connected to same DC bus. During the operation of multiple traction inverters with equal switching frequency and switching cycles in phase, a capacitor ripple current can result. The ripple current is an unwanted residual periodic variation of the DC output of a power supply which has been derived from an alternating current (AC) source. Capacitors can be added to the system to reduce or “smooth” the ripple current, which adds noise and distortion to the system. The capacitor size is based on meeting the worst case ripple current without exceeding each capacitor current limit. This configuration adds inefficiency, complexity, and cost to the system.

### BRIEF DESCRIPTION

In one embodiment, a ripple current control system includes plural inverters connected to a common bus. The inverters are configured to convert a direct current (DC) through the common bus to an alternating current (AC) by alternating different switches of the inverters between open and closed states in a switching cycle for each of the inverters. The system also includes a controller configured to reduce a ripple current conducted onto the common bus by controlling the inverters to apply a phase shift to the switching cycle of one or more of the inverters based on the number of the inverters.

In one embodiment, a ripple current control system includes plural inverter controllers configured to be operably coupled with plural inverters connected to a common bus. The inverters are configured to convert a direct current (DC) through the common bus to an alternating current (AC) by alternating different switches of the inverters between open and closed states in a switching cycle for each of the inverters. The system also includes a master controller configured to be operably coupled with the inverter controllers. The master controller is configured to predict a ripple current conducted onto the common bus from the inverters, and to reduce a ripple current that is conducted onto the common bus relative to the ripple current that is predicted by changing the switching cycle of one or more of the inverters.

In one embodiment, a method for controlling ripple currents includes determining a number of inverters connected to a common bus. The inverters are configured to convert a direct current (DC) through the common bus to an alternating current (AC) by alternating different switches of the inverters between open and closed states in a switching cycle for each of the inverters. The method also includes determining a phase shift to the switching cycle of one or more of the inverters, the phase shift determined based on the number of inverters, and reducing or eliminating a ripple current conducted onto the common bus by controlling the inverters to apply the phase shift to the switching cycle of one or more of the inverters.

### BRIEF DESCRIPTION OF THE DRAWINGS

The subject matter described herein will be better understood from reading the following description of non-limiting embodiments, with reference to the attached drawings, wherein below:

FIG. 1 illustrates a current control system according to one embodiment;

FIG. 2 illustrates one embodiment of an inverter shown in FIG. 1;

FIG. 3 illustrates one example of switching cycles R, Y, B of the inverters shown in FIG. 1 when the inverters operate with switching cycles that are in phase with each other;

FIG. 4 illustrates one example an amplitude spectrum of currents conducted on the buses of a circuit in a powered system shown in FIG. 1;

FIG. 5 illustrates phase-shifted switching cycles R, Y, B of the inverters shown in FIG. 1 according to one embodiment;

FIG. 6 illustrates one example an amplitude spectrum of currents conducted on the buses of the circuit in the powered system shown in FIG. 1;

FIG. 7 illustrates individual ripple current vectors generated at corresponding integer multiples of the switching frequency (e.g., Iₛ₁, Iₛ₂, Iₛ₃, etc.) of the inverters (shown in FIG. 1) and a total ripple current vector generated by the inverters according to one example;

FIG. 8 illustrates individual ripple current vectors generated at twice the switching frequency (e.g., Iₛ₂) of the inverters 104 (shown in FIG. 1) according to one example;

FIG. 9 illustrates individual ripple current vectors generated at four times the switching frequency (e.g., Iₛ₄) of the inverters (shown in FIG. 1) according to one example;

FIG. 10 illustrates individual ripple current vectors generated at six times the switching frequency (e.g., Iₛ₆) of the inverters (shown in FIG. 1) according to one example;

FIG. 11 illustrates individual ripple current vectors and a total ripple current vector generated at twelve times the switching frequency (e.g., Iₛ₁₂) of the inverters (shown in FIG. 1) according to one example;

FIG. 12 illustrates phase-shifted switching cycles R, Y, B of the inverters shown in FIG. 1 according to another embodiment;

FIG. 13 illustrates individual ripple current vectors generated at integer multiples of the switching frequency of the inverters (shown in FIG. 1) and a total ripple current vector generated by the inverters according to one example;

FIG. 14 illustrates individual ripple current vectors generated at twice the switching frequency (e.g., Iₛ₂) of the inverters (shown in FIG. 1) according to one example;

FIG. 15 illustrates individual ripple current vectors generated at four times the switching frequency (e.g., Iₛ₄) of the inverters (shown in FIG. 1) according to one example;

FIG. 16 illustrates individual ripple current vectors generated at six times the switching frequency (e.g., Iₛ₆) of the inverters (shown in FIG. 1) according to one example;

FIG. 17 illustrates individual ripple current vectors generated at twelve times the switching frequency (e.g., Iₛ₁₂) of the inverters (shown in FIG. 1) according to one example;

FIG. 18 illustrates one example an amplitude spectrum of currents conducted on the buses of the circuit in the powered system shown in FIG. 1;

FIG. 19 illustrates an additional example of phase shifts or angles that may be applied to the switching cycles of different numbers of inverters connected to the same bus in FIG. 1 in order to reduce or eliminate the ripple currents at twice the switching frequencies of the inverters;

FIG. 20 illustrates an additional example of phase shifts or angles that may be applied to the switching cycles of different numbers of inverters connected to the same bus in FIG. 1 in order to reduce or eliminate the ripple currents at twice the switching frequencies of the inverters;

FIG. 21 illustrates an additional example of phase shifts or angles that may be applied to the switching cycles of different numbers of inverters connected to the same bus in FIG. 1 in order to reduce or eliminate the ripple currents at twice the switching frequencies of the inverters;

FIG. 22 illustrates an additional example of phase shifts or angles that may be applied to the switching cycles of different numbers of inverters connected to the same bus in FIG. 1 in order to reduce or eliminate the ripple currents at twice the switching frequencies of the inverters;

FIG. 23 illustrates an additional example of phase shifts or angles that may be applied to the switching cycles of different numbers of inverters connected to the same bus in FIG. 1 in order to reduce or eliminate the ripple currents at twice the switching frequencies of the inverters;

FIG. 24 illustrates a set of prospective ripple currents for operating conditions of the circuit in the powered system shown in FIG. 1 according to one example;

FIG. 25 illustrates a different set of prospective ripple currents for different operating conditions of the circuit in the powered system shown in FIG. 1 according to another example;

FIG. 26 illustrates a different set of prospective ripple currents for different operating conditions of the circuit in the powered system shown in FIG. 1 according to another example;

FIG. 27 illustrates a different set of prospective ripple currents for different operating conditions of the circuit in the powered system shown in FIG. 1 according to another example;

FIG. 28 illustrates one example of the controller shown in FIG. 1; and

FIG. 29 illustrates a flowchart of one embodiment of a method for reducing ripple control current.

### DETAILED DESCRIPTION

One or more embodiments of the inventive subject matter described herein provide systems and methods comprising plural inverters connected to a common bus. The inverters are configured to convert a direct current (DC) through the common bus to an alternating current (AC) at a switching frequency for different phases of the AC that is output from the inverters. A controller is configured to reduce a capacitor ripple current conducted onto the common bus by determining potential ripple currents that would be generated by the inverters and conducted on the common bus based on a load placed on the powered system. The controller also adjusts the inverters to change the phases of the AC that is output from the inverters based on the number of the inverters. The ripple current may be reduced relative to a ripple current that is or would be produced if the inverters were not controlled to apply phase shifts based on the number of inverters. For example, if the inverters are controlled with phase shifts that are not based on the number of inverters or if the inverters are not controlled with phase shifts, then the ripple current generated by these inverters may be greater than if the phase shifts were applied to the inverters or if the phase shifts are based on the number of inverters.

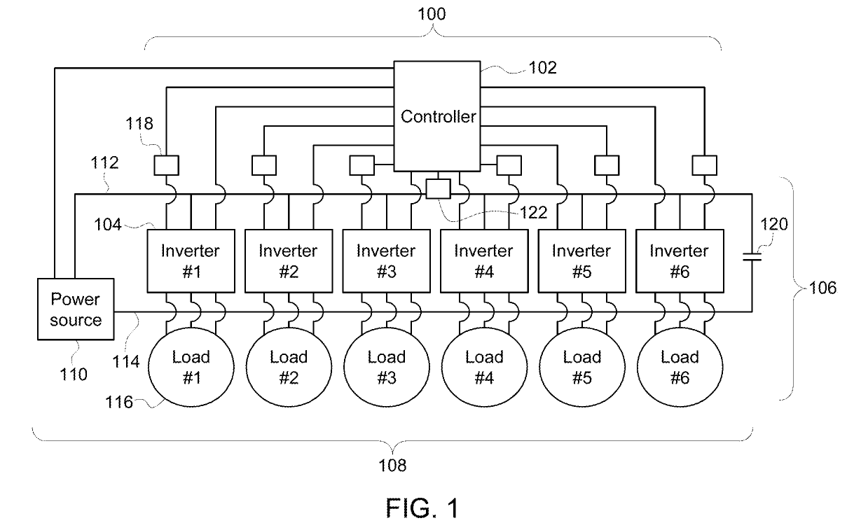

FIG. 1 illustrates a current control system 100 according to one embodiment. The system includes a controller 102 operably connected with plural inverters 104 (“Inverter #1”, “Inverter #2”, “Inverter #3”, “Inverter #4”, “Inverter #5”, and “Inverter #6” in FIG. 1) of a circuit 106 in a powered system 108. The controller can be connected with the inverters via one or more wired and/or wireless connections to allow the controller to monitor and/or control operations of the inverters, as described herein. The controller includes hardware circuitry that includes and/or is connected with one or more processors (e.g., microprocessors, field programmable gate arrays, and/or integrated circuits) that perform the operations described herein. The circuit represents one or more hardware circuits that connect a power source 110 with the inverters along common buses 112, 114. The power source can represent one or more devices capable of providing electric current to the inverters along the common buses, such as an alternator and/or generator coupled with an engine, one or more batteries, etc. The buses include a positive bus 112, which can conduct a positive portion of a direct current (DC) from the power source to the inverters, and a negative bus 114, which can conduct a negative portion of the DC between the power source with the inverters. The buses may be referred to as common buses because multiple inverters are connected with the power source by the same positive DC bus and the same negative DC bus. In one embodiment, each of the buses 112, 114 can be a single conductive body or pathway, or multiple conductive bodies or pathways, with the inverters connected to the buses in parallel to each other.

The circuit conducts DC from the power source to the inverters, which convert the DC into alternating currents (ACs), which are supplied to multiple loads 116 (“Load #1”, “Load #2”, “Load #3”, “Load #4”, “Load #5”, and “Load #6” in FIG. 1). The loads can represent a variety of devices that perform work using the AC received from the inverters. In one embodiment, the powered system includes or is a vehicle, with the loads representing traction motors, fan motors (e.g., blowers), cooling systems, heating systems, compressors, etc. Alternatively, the powered system may include or be a stationary system, such as a power generator. The number of inverters and loads shown in FIG. 1 are provided as one example. Optionally, as few as two inverters or more than six inverters may be used.

The controller and power source may be communicatively coupled by one or more wired and/or wireless connections. The controller may monitor operation of the power source based on inputs to and/or outputs from the power source. For example, the controller may determine the current demanded from the power source by the loads based on input throttle settings of the motors (e.g., loads).

Operation of the inverters may create or induce a ripple voltage or ripple current (Vac) on the positive and/or negative DC buses. A capacitor or capacitive element 120 may be connected between the positive and negative DC buses to smooth out (e.g., reduce) variations in this ripple voltage or current. In some operating conditions, however, the capacitor or capacitive element may be unable to reduce the ripple voltage or ripple current and prevent this voltage or current from interfering in operations of the powered system.

The control system includes inverter sensors 118 that monitor one or more characteristics of the inverters. In one embodiment, the inverter sensors include voltmeters or ammeters that measure the voltages and/or currents conducted to the inverters from the power source via one or more of the common buses. As shown in FIG. 1, each inverter may have inverter sensors connected to the inverter for the controller to monitor characteristics of each inverter. These sensors can measure the voltages provided to the inverters and/or the currents and/or voltages that are output by the inverters. For example, an inverter sensor may be coupled with the inverter between the positive DC bus and the inverter to measure the input voltage or current and one or more additional inverter sensors may be coupled with the inverter between the inverter and the load to measure the AC that is output by the inverter. The control system includes a ripple current sensor 122 that can measure the amount of ripple current conducted on the bus 112 and/or the bus 114. The ripple current sensor may include a voltmeter and/or ammeter that measures the voltage and/or current conducted on the bus 112 and/or the bus 114 as the ripple current. This current may be measured as the voltage and/or current that is in excess of the voltage and/or current provided by the power source, which may be known by the controller based on communication between the controller and the power source. While the ripple current sensor is shown as being connected with the positive DC bus, optionally, the ripple current sensor may be connected with the negative DC bus. Alternatively, a fewer or greater number of sensors may be used.

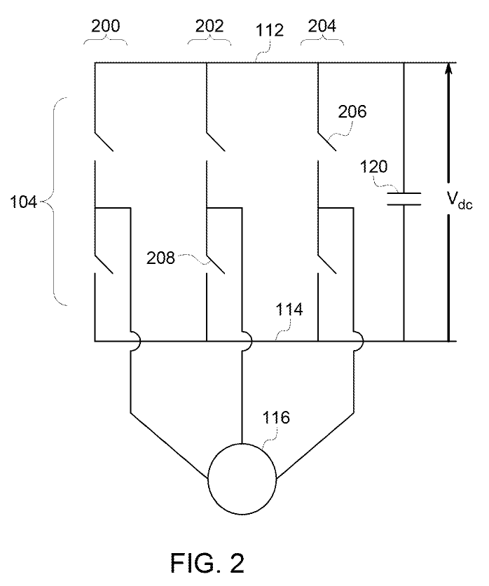

FIG. 2 illustrates one embodiment of an inverter 104 of the inverters shown in FIG. 1. The inverter may be a two level inverter having three sets or legs 200, 202, 204 of positive and negative switches 206, 208. Each leg of switches is connected with the positive and negative DC buses 112, 114 and converts DC received along the positive DC bus into one phase of the AC that is conducted to the load 116.

The three sets or legs of switches in the inverter convert the DC received along the same positive DC bus into three different phases of AC supplied to the load. The positive and negative switches in each leg of an inverter may alternate between closed and open states during switching cycles. A switching cycle defines the time periods that the positive switch in an inverter leg is closed and the negative switch in the same inverter leg is open, the time periods that the positive switch in the inverter leg is open and the negative switch in the same inverter leg is closed, and the frequency (or how rapidly) these switches alternate between open and closed states.

For example, for each leg, the positive switch may close while the negative switch in the same leg may open for a first time period to conduct a positive portion of the voltage of the AC to the load. During a different, second time period, the positive switch in the leg may open while the negative switch in the leg closes to conduct a negative portion of the voltage of the AC to the load. The positive and negative switches in each leg of the inverter may alternate between open and closed positions, respectively, at a switching frequency to cause the DC to be converted into the AC.

Commonality in the phases of switching frequencies of the multiple inverters connected to the same positive and negative DC buses (as shown in FIG. 1) can create the ripple voltage or ripple current in the circuit 106 of the powered system 108 shown in FIG. 1. This ripple current may be created by residual variations in the DC output by the inverters during creation of the AC. The ripple current may be undesirable as the current can negatively impact control or operation of the loads. For example, traction motors may not operate at the desired speeds or provide the desired output if the ripple current becomes too large. The ripple voltage or current may be larger (or largest) during time periods that the switching cycles of the inverters have the same phase. This can occur when the positive and negative switches in the same leg (e.g., the leg 200, the leg 202, and/or the leg 204 switch between the closed and open states at the same phase (e.g., there is little to no phase differences between the oscillating between open and closed states). This can be problematic in powered systems that continually or occasionally operate multiple inverters at the same frequency, such as in a vehicle operating multiple traction motors at the same speed, with the traction motors being individually controlled by separate inverters.

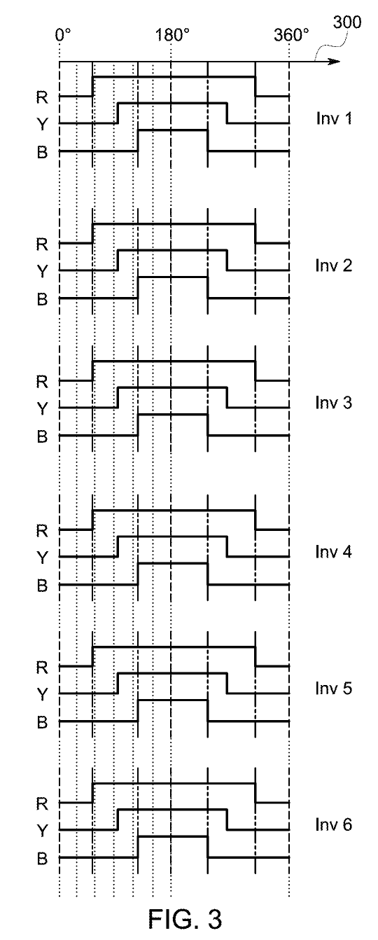

FIG. 3 illustrates one example of switching cycles R, Y, B of the inverters 104 shown in FIG. 1 when the inverters operate with switching cycles that are in phase with each other. For each inverter (“Inv 1”, “Inv 2”, “Inv 3”, “Inv 4”, “Inv 5”, and “Inv 6” in FIG. 3), a switching cycle R, Y, B is shown for each of the legs 200, 202, 204 of the inverter (shown in FIG. 2). The switching cycle R can represent the rate at which the positive and negative switches 206, 208 (shown in FIG. 2) of the first legs 200 of the inverters alternate between closed and open states, the switching cycle Y can represent the rate at which the positive and negative switches of the second legs 202 of the inverters alternate between closed and open states, and the switching cycle B can represent the rate at which the positive and negative switches of the third legs 204 of the inverters alternate between closed and open states. The switching cycles for the inverters are shown alongside a horizontal axis 300 representative of different phases of the switching cycles (e.g., in units of degrees with 360 degrees indicating a complete switching cycle). The R phase of the inverters indicates that the R phase switches at sixty degrees, the Y phase switches at ninety and 270 degrees, and the B phase switches at 120 and 240 degrees.

As shown in FIG. 3, the switching cycles are the same for the corresponding legs in each of the inverters. This results in the switching cycles for the same legs in the different inverters having no phase differences. Having in-phase switching cycles (even with phase difference between fundamental components of output of multiple inverters) can significantly increase the amount of ripple current created and conducted on the common buses 112, 114 of the circuit 106 in the powered system 108 shown in FIG. 1.

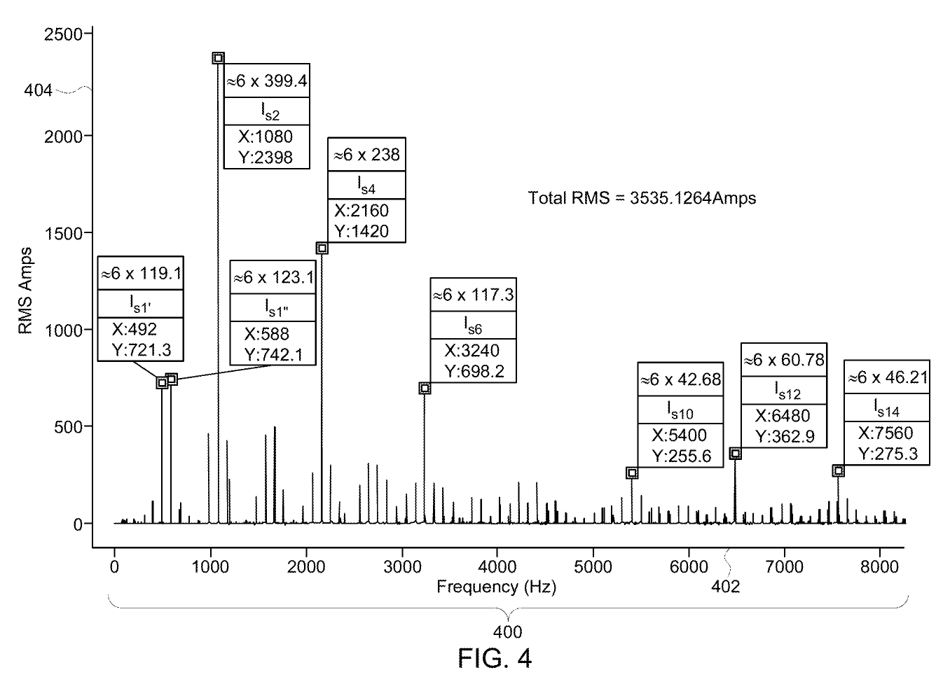

FIG. 4 illustrates one example an amplitude spectrum of currents 400 conducted on the buses 112, 114 of the circuit 106 in the powered system 108 shown in FIG. 1. The currents shown in FIG. 4 are shown alongside a horizontal axis 402 representative of frequencies of the ripple currents (e.g., in units of hertz) and a vertical axis 404 representative of magnitudes of the ripple currents, such as root mean square (RMS) values of the ripple currents in units of amperes.

The ripple currents represent the currents conducted on the positive and negative DC buses during a time period that phases of the switching frequencies of the inverters 104 are the same. For example, the currents shown in FIG. 4 may be created when the phases of the switching frequencies of the inverters are as shown in FIG. 3.

In the illustrated example, the currents are generated when the switching frequencies of the inverters is 540 hertz with the current conducted from the inverters to the loads 116 (shown in FIG. 1) being 867 amperes. Alternatively, another switching frequency and/or load current may be used.

As shown in FIG. 4, two load current peaks I_{s1′}, I_{s1′} represent the currents generated by the inverters operating at the switching frequencies to provide AC to the loads. Because the inverters operate at switching frequencies having the same phases, additional peaks in the currents are generated. These peaks can represent the ripple currents conducted along the positive and negative DC buses. These peaks may occur along the horizontal axis at or near even multiples of the switching frequency (e.g., twice the switching frequency, four times the switching frequency, six times the switching frequency, and so on). A ripple current peak Iₛ₂ represents the ripple current having a frequency that is twice the switching frequency, a ripple current peak Iₛ₄ represents the ripple current having a frequency that is four times the switching frequency, a ripple current peak Iₛ₆ represents the ripple current having a frequency that is six times the switching frequency, a ripple current peak Iₛ₁₀ represents the ripple current having a frequency that is ten times the switching frequency, a ripple current peak Iₛ₁₂ represents the ripple current having a frequency that is twelve times the switching frequency, and a ripple current peak Iₛ₁₄ represents the ripple current having a frequency that is fourteen times the switching frequency. The coordinates of these load current peaks and ripple current peaks along the horizontal (or X) axis and along the vertical (or Y) axis are shown near the respective peaks.

The total RMS of the ripple current peaks is approximately 3,500 amperes, as shown in FIG. 4. This magnitude of ripple current on the positive and negative DC buses (e.g., relative to the load current of 540 amperes) can interfere with operation of the inverters and/or loads. For example, the speed at which traction motors operate may not be able to be accurately controlled when the ripple current is as large as or larger than the load current. Due to high capacitor ripple current, the DC link voltage ripple may have higher magnitude, which may lead to higher harmonic content on load input voltage, which ultimately may lead to higher magnitude pulsating torque for motor loads. One or more of the traction motors may operate at faster speeds than is desired. In order to prevent this, larger and/or additional capacitors or capacitive elements 120 (shown in FIG. 1) may be added to the circuit 106 (shown in FIG. 1).

In order to reduce the ripple current, phases in the switching cycles between connected inverters can be shifted relative to each other. The shift in switching cycles between the inverters reduces the net ripple current by cancelling out single or multiple frequency components and/or reducing multiple frequency components of the ripple current contributed by each inverter.

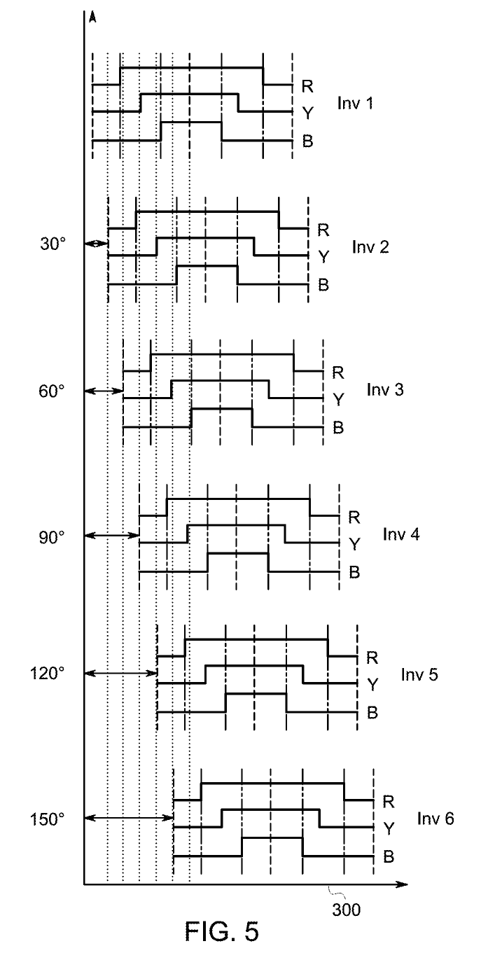

FIG. 5 illustrates phase-shifted switching cycles R, Y, B of the inverters 104 shown in FIG. 1 according to one embodiment. Similar to as described above in connection with FIG. 3, for each inverter, the switching cycles R, Y, B are shown for the corresponding legs of the same inverter.

As shown in FIG. 5, the switching cycles are not the same for the corresponding legs in each of the inverters. The phases of the switching cycles have been delayed or changed so that the switching cycles of different inverters are shifted relative to each other. In the illustrated embodiment, the switching cycles are shifted by 30 degrees relative to each other. As a result, the positive switches in the same leg of different inverters close at different times, the positive switches in the same leg of different inverters open at different times, the negative switches in the same leg of different inverters close at different times, and the negative switches in the same leg of different inverters open at different times (e.g., at times shifted by 30 degrees within the switching cycles). The phase sequence may not be required to be RYB phases in all situations, but can be another sequence with appropriate phase shift between switching cycles of multiple inverters applied to achieve the reduction in net ripple current in dc link capacitors.

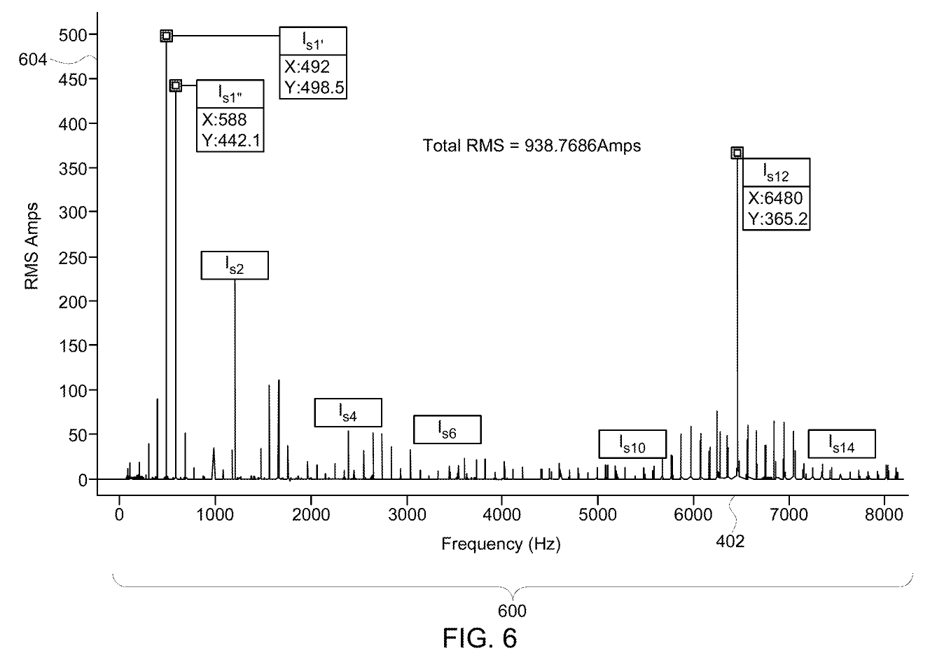

FIG. 6 illustrates one example an amplitude spectrum of currents 600 conducted on the buses 112, 114 of the circuit 106 in the powered system 108 shown in FIG. 1. Similar to the current shown in FIG. 4, the currents shown in FIG. 6 are shown alongside the horizontal axis 402 representative of frequencies of the currents and a vertical axis 604 representative of magnitudes of the currents, such as RMS values of the currents in units of amperes. In the illustrated example, the currents are generated when the switching frequencies of the inverters is 540 hertz with the current conducted from the inverters to the loads 116 (shown in FIG. 1) being 867 amperes. Alternatively, another switching frequency and/or load current may be used.

As shown by a comparison of the currents 400, 600 shown in FIGS. 4 and 6, the magnitudes of the ripple currents conducted on the positive and negative DC buses are significantly reduced by shifting the phases of the switching frequencies. While the load currents I_{s1′}, I_{s1″} remain at the same magnitudes in FIGS. 4 and 6 (to drive the loads), the ripple currents Iₛ₂, Iₛ₄, Iₛ₆, Iₛ₁₀, Iₛ₁₂, Iₛ₁₄ are significantly reduced by shifting phases of the switching frequencies. The total RMS of the ripple currents is approximately 900 amperes, which is a significant reduction relative to the ripple currents shown in FIG. 4.

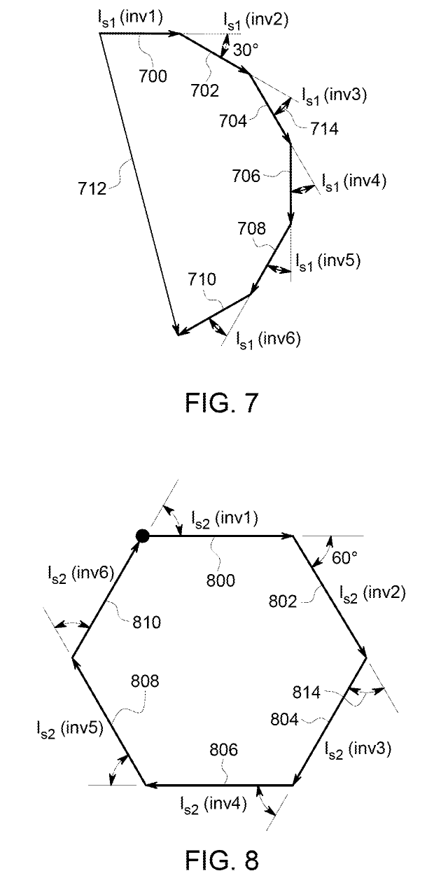

FIG. 7 illustrates individual ripple current vectors 700, 702, 704, 706, 708, 710 generated at corresponding integer multiples of the switching frequency (e.g., Iₛ₁, Iₛ₂, Iₛ₃, etc.) of the inverters 104 (shown in FIG. 1) and a total ripple current vector 712 generated by the inverters according to one example. The individual ripple current vectors represent the ripple currents (or portions of the total ripple current) generated by the different inverters 104. For example, the ripple current vector 700 may represent the ripple current generated by the first inverter (“inv 1” in FIG. 7), the ripple current vector 702 may represent the ripple current generated by the second inverter (“inv 2” in FIG. 7), and so on. The individual ripple current vectors are added together with lengths of each of the individual ripple current vectors representing the magnitude (e.g., RMS) of the ripple current generated by the corresponding inverter. The directions of the individual ripple current vectors indicate the phase shifts between the switching cycles of the various inverters.

For example, the first ripple current vector 700 represents the ripple current having a frequency at the switching frequency of the inverters and that is generated by the first inverter. The first ripple current vector is oriented horizontally, but may be oriented in another direction. The second ripple current vector 702 represents the ripple current having a frequency at the switching frequency of the inverters and that is generated by the second inverter. The second ripple current vector is added to the end of the first ripple current vector, and is oriented in a direction that is equal to the phase shift between the switching cycles of the first and second inverters. For example, the second ripple current vector may be oriented at an angle 714 of thirty degrees (e.g., the phase shift). The third through sixth individual ripple current vectors 704, 706, 708, 710 are added in a similar manner, with the individual ripple current vectors oriented relative to each other at angles equal to the phase shift.

The total ripple current vector extends from the starting location or point of the first individual ripple current vector to the ending location or point of the sixth (or last) individual ripple current vector. The length of the total ripple current vector indicates the magnitude of the total ripple current (e.g., the RMS) generated by the six inverters at the switching frequency. As shown in FIG. 7, the total ripple current is relatively large. This total ripple current vector can represent the magnitudes of the ripple currents I_{s1′}, I_{s1″} shown in FIG. 6.

FIG. 8 illustrates individual ripple current vectors 800, 802, 804, 806, 808, 810 generated at twice the switching frequency (e.g., Iₛ₂) of the inverters 104 (shown in FIG. 1) according to one example. The individual ripple current vectors represent the ripple currents (or portions of the total ripple current) generated by the different inverters 104. For example, the ripple current vector 800 may represent the ripple current generated by the first inverter, the ripple current vector 802 may represent the ripple current generated by the second inverter, and so on. The individual ripple current vectors are added together with lengths of each of the individual ripple current vectors representing the magnitude (e.g., RMS) of the ripple current generated by the corresponding inverter. The directions of the individual ripple current vectors indicate or are based on (e.g., multiples of) the phase shifts between the switching cycles of the various inverters.

Similar to the vectors shown in FIG. 7, the individual ripple current vectors for twice the switching frequency may be added together, with the individual ripple current vectors oriented relative to each other at angles 814 that are twice the phase shift. For example, for the frequency that is twice the switching frequency, the angle between added individual ripple current vectors is twice the phase shift between the switching cycles of the inverters (e.g., two times thirty degrees in this example, or sixty degrees).

In contrast to the total ripple current vector shown in FIG. 7, there is little to no total ripple current vector in the example of FIG. 8. The starting location or point of the first individual ripple current vector and the ending location or point of the sixth (or last) individual ripple current vector are at the same location or very close to each other. As a result, there is no little to no length for a total ripple current vector at a frequency that is twice the switching frequency, which indicates that there is little to no total ripple current (e.g., the RMS) generated by the six inverters at twice the switching frequency (e.g., Iₛ₂). This is shown by the smaller total ripple current Iₛ₂ in FIG. 6. Some ripple current may still be generated due to the phase shifts between different pairs of the inventers not being exactly the same.

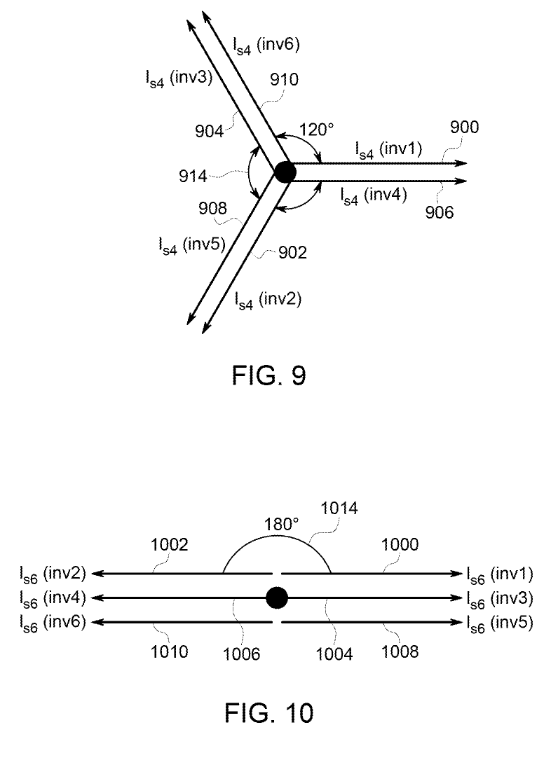

FIG. 9 illustrates individual ripple current vectors 900, 902, 904, 906, 908, 910 generated at four times the switching frequency (e.g., Iₛ₄) of the inverters 104 (shown in FIG. 1) according to one example. The individual ripple current vectors represent the ripple currents (or portions of the total ripple current) generated by the different inverters 104. For example, the ripple current vector 900 may represent the ripple current generated by the first inverter, the ripple current vector 902 may represent the ripple current generated by the second inverter, and so on. The individual ripple current vectors are added together with lengths of each of the individual ripple current vectors representing the magnitude (e.g., RMS) of the ripple current generated by the corresponding inverter. The directions of the individual ripple current vectors indicate or are based on (e.g., multiples of) the phase shifts between the switching cycles of the various inverters.

Similar to the vectors shown in FIGS. 7 and 8, the individual ripple current vectors for four times the switching frequency may be added together, with the individual ripple current vectors oriented relative to each other at angles 914 that are four times the phase shift. For example, for the frequency that is four times the switching frequency, the angle between added individual ripple current vectors is a product of four and the phase shift between the switching cycles of the inverters (e.g., four times thirty degrees in this example, or 120 degrees).

In contrast to the total ripple current vector shown in FIG. 7, there is little to no total ripple current vector in the example of FIG. 9. The starting location or point of the first individual ripple current vector and the ending location or point of the sixth (or last) individual ripple current vector are at the same location or very close to each other. As a result, there is little to no length for a total ripple current vector, which indicates that there is little to no total ripple current (e.g., the RMS) generated by the six inverters at four times the switching frequency (e.g., Iₛ₄). This is shown by the smaller total ripple current Iₛ₄ in FIG. 6. Some ripple current may still be generated due to the phase shifts between different pairs of the inventers not being exactly the same.

FIG. 10 illustrates individual ripple current vectors 1000, 1002, 1004, 1006, 1008, 1010 generated at six times the switching frequency (e.g., Iₛ₆) of the inverters 104 (shown in FIG. 1) according to one example. The individual ripple current vectors represent the ripple currents (or portions of the total ripple current) generated by the different inverters 104. For example, the ripple current vector 1000 may represent the ripple current generated by the first inverter, the ripple current vector 1002 may represent the ripple current generated by the second inverter, and so on. The individual ripple current vectors are added together with lengths of each of the individual ripple current vectors representing the magnitude (e.g., RMS) of the ripple current generated by the corresponding inverter. The directions of the individual ripple current vectors indicate or are based on (e.g., multiples of) the phase shifts between the switching cycles of the various inverters.

Similar to the vectors shown in FIGS. 7 through 9, the individual ripple current vectors for six times the switching frequency may be added together, with the individual ripple current vectors oriented relative to each other at angles 1014 that are six times the phase shift. For example, for the frequency that is six times the switching frequency, the angle between added individual ripple current vectors is a product of six and the phase shift between the switching cycles of the inverters (e.g., six times thirty degrees in this example, or 180 degrees).

In contrast to the total ripple current vector shown in FIG. 7, there is little to no total ripple current vector in the example of FIG. 10. The starting location or point of the first individual ripple current vector and the ending location or point of the sixth (or last) individual ripple current vector are at the same location or very close to each other. As a result, there is little to no length for a total ripple current vector, which indicates that there is little to no total ripple current (e.g., the RMS) generated by the six inverters at six times the switching frequency (e.g., Iₛ₆). This is shown by the smaller total ripple current Iₛ₆ in FIG. 6. Some ripple current may still be generated due to the phase shifts between different pairs of the inventers not being exactly the same.

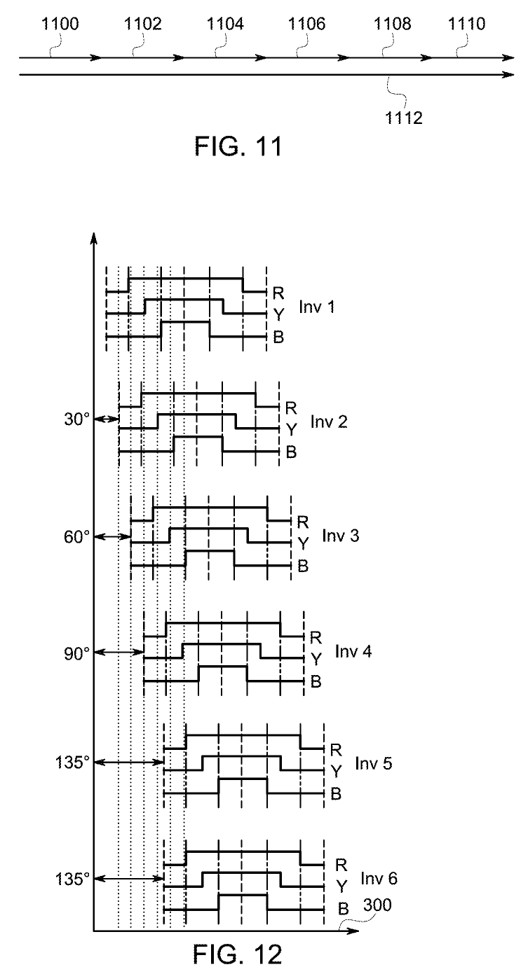

FIG. 11 illustrates individual ripple current vectors 1100, 1102, 1104, 1106, 1108, 1110 and a total ripple current vector 1112 generated at twelve times the switching frequency (e.g., Iₛ₁₂) of the inverters 104 (shown in FIG. 1) according to one example. The individual ripple current vectors represent the ripple currents (or portions of the total ripple current) generated by the different inverters 104. For example, the ripple current vector 1100 may represent the ripple current generated by the first inverter, the ripple current vector 1102 may represent the ripple current generated by the second inverter, and so on. The individual ripple current vectors are added together with lengths of each of the individual ripple current vectors representing the magnitude (e.g., RMS) of the ripple current generated by the corresponding inverter. The directions of the individual ripple current vectors indicate the phase shifts between the switching cycles of the various inverters.

Similar to the vectors shown in FIGS. 7 through 10, the individual ripple current vectors for twelve times the switching frequency may be added together, with the individual ripple current vectors oriented relative to each other at angles that are twelve times the phase shift. For example, for the frequency that is twelve times the switching frequency, the angle between added individual ripple current vectors is a product of twelve and the phase shift between the switching cycles of the inverters (e.g., twelve times thirty degrees in this example, or 360 degrees). Because this multiple is 360 degrees, the individual ripple current vectors are oriented in the same direction, as shown in FIG. 11.

In contrast to the total ripple current vectors shown in FIGS. 8 through 10, there is a large total ripple current vector in the example of FIG. 11. The starting location or point of the first individual ripple current vector and the ending location or point of the sixth (or last) individual ripple current vector are at spaced apart locations that are not close to each other. As a result, there is a longer length for a total ripple current vector, which indicates that there is a relatively large total ripple current (e.g., the RMS) generated by the six inverters at twelve times the switching frequency (e.g., Iₛ₁₂). This is shown by the larger total ripple current Iₛ₁₂ in FIG. 6.

With applying the phase shift to the switching cycles of the inverters, much of the ripple current created by the inverters is reduced. While some of the frequencies of the ripple current may still be present, the total ripple current created by the inverters is significantly reduced relative to not shifting the phases of the switching cycles (e.g., 939 amperes versus 3,540 amperes of total ripple current).

The amount of phase shift between the switching cycles is dependent upon the number of inverters connected to and powered by current received along the same bus or buses in one embodiment. Optionally, the phase shift between the switching cycles can also be dependent upon the magnitude of load current generated by one or more of the inverters and/or the frequencies of the ripple current that are sought or selected to be reduced or eliminated. For example, different phase shifts may be used for different inverters so that the switching cycles of all inverters are not shifted relative to each other by the same phase shift or an integer multiple of the same phase shift. Instead, the phase shift between some inverters may be a different phase shift or a non-integer multiple of the same phase shift. As another example, different phase shifts may be used for different inverters to reduce or eliminate one ripple current frequency (e.g., the ripple current occurring at twelve times the switching frequency) more than one or more other ripple current frequencies (e.g., the ripple currents occurring at six times the switching frequency).

FIG. 12 illustrates phase-shifted switching cycles R, Y, B of the inverters 104 shown in FIG. 1 according to another embodiment. Similar to as described above in connection with FIGS. 3 and 5, for each inverter, the switching cycles R, Y, B are shown for the corresponding legs of the same inverter. As shown in FIG. 12, the switching cycles are not the same for the corresponding legs in each of the inverters. The phases of the switching cycles have been delayed or changed so that the switching cycles of different inverters are shifted relative to each other. In the illustrated embodiment and in contrast to the embodiment shown in FIG. 5, however, the switching cycles are phase shifted relative to each other by different amounts.

The switching cycles of the second through fourth inverters are phase shifted or delayed by thirty degrees relative to each other. For example, the switching cycle of the second inverter is phase shifted or delayed by thirty degrees relative to the switching cycle of the first inverter, the switching cycle of the third inverter is phase shifted or delayed by thirty degrees relative to the switching cycle of the second inverter (and sixty degrees relative to the switching cycle of the first inverter), and the switching cycle of the fourth inverter is phase shifted or delayed by thirty degrees relative to the switching cycle of the third inverter (and ninety degrees relative to the switching cycle of the first inverter).

The switching cycles of the fifth and sixth inverters, however, are shifted by different amounts. In the illustrated example, the switching cycle of the fifth inverter is phase shifted or delayed by forty-five degrees relative to the fourth inverter (and 135 degrees relative to the first inverter), instead of thirty degrees. Additionally, the switching cycle of the sixth inverter is not phase shifted or delayed relative to the fifth inverter (but is shifted or delayed by 135 degrees relative to the first inverter). The phase shifts for the fifth and sixth inverters may be different due to the load currents produced by these inverters being larger than the other inverters and/or due to a desire or objective to eliminate or reduce the total ripple current at particular or designated frequencies.

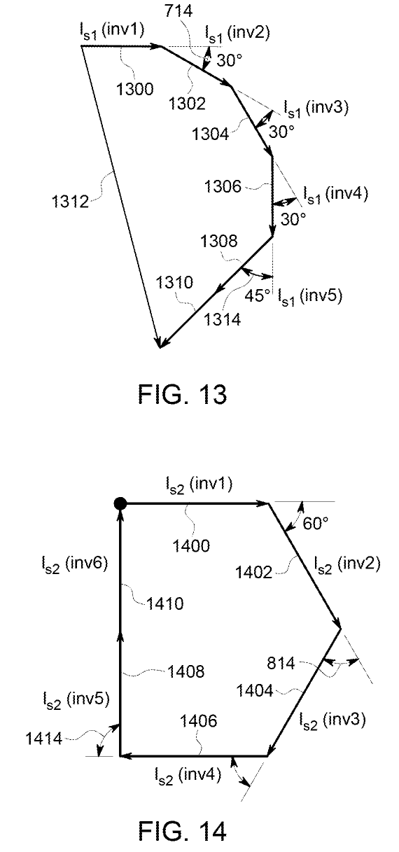

FIG. 13 illustrates individual ripple current vectors 1300, 1302, 1304, 1306, 1308, 1310 generated at integer multiples of the switching frequency of the inverters 104 (shown in FIG. 1) and a total ripple current vector 1312 generated by the inverters according to one example. Similar to as described above in connection with FIGS. 7 through 11, the individual ripple current vectors represent the ripple currents generated by different inverters, and may be added together. The individual ripple current vectors representative of the ripple currents generated by the first through fourth inverters may be oriented relative to each other at the angle 714 (e.g., indicative of the phase shift of thirty degrees). The individual ripple current vectors for the fifth and sixth inverters, however, are oriented relative to the individual ripple current vector for the fourth inverter at a different angle 1314 (e.g., of forty-five degrees). The individual ripple current vector for the sixth inverter is not oriented at an angle relative to the individual ripple current vector for the fifth inverter due to the switching cycles of the fifth and sixth inverters not being phase shifted relative to each other.

While the lengths of the individual ripple current vectors are the same (indicating that the same amount of ripple current is generated by each of the inverters), optionally, the length of one or more of these vectors may be longer or shorter than others. The length of one or more vectors may be shorter to indicate that less ripple current is generated by the corresponding inverter or longer to indicate that more ripple current is generated by the corresponding inverter.

The total ripple current vector extends from the starting location or point of the first individual ripple current vector to the ending location or point of the sixth (or last) individual ripple current vector. The length of the total ripple current vector indicates the magnitude of the total ripple current (e.g., the RMS) generated by the six inverters at the switching frequency. As shown in FIG. 13, the total ripple current is relatively large.

FIG. 14 illustrates individual ripple current vectors 1400, 1402, 1404, 1406, 1408, 1410 generated at twice the switching frequency (e.g., Iₛ₂) of the inverters 104 (shown in FIG. 1) according to one example. The individual ripple current vectors represent the ripple currents (or portions of the total ripple current) generated by the different inverters 104. For example, the ripple current vector 1400 may represent the ripple current generated by the first inverter, the ripple current vector 1402 may represent the ripple current generated by the second inverter, and so on. The individual ripple current vectors are added together with lengths of each of the individual ripple current vectors representing the magnitude (e.g., RMS) of the ripple current generated by the corresponding inverter. The directions of the individual ripple current vectors indicate or are based on (e.g., multiples of) the phase shifts between the switching cycles of the various inverters.

Similar to the vectors shown in FIG. 7, the individual ripple current vectors for twice the switching frequency may be added together, with the individual ripple current vectors for some of the inverters oriented relative to each other at the angles 814 that are twice the phase shift (e.g., sixty degrees). The individual ripple current vectors for the fifth and sixth inverters, however, are oriented relative to the individual ripple current vector for the fourth inverter at a different angle 1414 (such as an angle of two times forty-five degrees, or ninety degrees). This angle is twice the angle 1314 used for the fifth and sixth inverters at the switching frequency. The individual ripple current vector for the sixth inverter is not oriented at an angle relative to the individual ripple current vector for the fifth inverter due to the switching cycles of the fifth and sixth inverters not being phase shifted relative to each other.

In contrast to the total ripple current vector shown in FIG. 13, there is little to no total ripple current vector in the example of FIG. 14. The starting location or point of the first individual ripple current vector and the ending location or point of the sixth (or last) individual ripple current vector are at the same location or very close to each other. As a result, there is no little to no length for a total ripple current vector at a frequency that is twice the switching frequency, which indicates that there is little to no total ripple current (e.g., the RMS) generated by the six inverters at twice the switching frequency (e.g., Iₛ₂). Some ripple current may still be generated due to the phase shifts between different pairs of the inventers not being exactly the same.

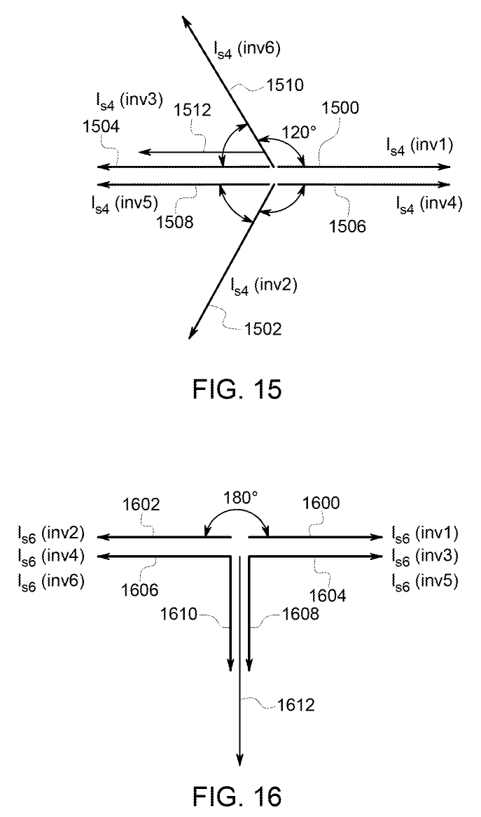

FIG. 15 illustrates individual ripple current vectors 1500, 1502, 1504, 1506, 1508, 1510 generated at four times the switching frequency (e.g., Iₛ₄) of the inverters 104 (shown in FIG. 1) according to one example. The individual ripple current vectors represent the ripple currents (or portions of the total ripple current) generated by the different inverters. The ripple current vector 1500 may represent the ripple current generated by the first inverter, the ripple current vector 1502 may represent the ripple current generated by the second inverter, and so on. The individual ripple current vectors are added together with lengths of each of the individual ripple current vectors representing the magnitude (e.g., RMS) of the ripple current generated by the corresponding inverter. The directions of the individual ripple current vectors indicate or are based on (e.g., multiples of) the phase shifts between the switching cycles of the various inverters.

The individual ripple current vectors for the first through fourth inverters (e.g., vectors 1500, 1502, 1504, 1506) are oriented relative to each other at the angles 914 (shown in FIG. 9) that are four times the phase shift. The individual ripple current vectors for the fifth and sixth inverters, however, are oriented relative to the individual ripple current vector for the fourth inverter at a different angle (e.g., an angle of four times forty-five degrees, or 180 degrees). This angle is four times the angle used for the fifth and sixth inverters at the switching frequency.

There is a relatively small total ripple current vector 1512 in the example of FIG. 15. The starting location or point of the first individual ripple current vector and the ending location or point of the sixth (or last) individual ripple current vector are not at the same location, but are relatively close to each other (e.g., closer together than a length of any one of the individual ripple current vectors shown in FIG. 15). As a result, while there is a total ripple current generated by the inverters, the total ripple current is relatively small.

FIG. 16 illustrates individual ripple current vectors 1600, 1602, 1604, 1606, 1608, 1610 generated at six times the switching frequency (e.g., Iₛ₆) of the inverters 104 (shown in FIG. 1) according to one example. The individual ripple current vectors represent the ripple currents (or portions of the total ripple current) generated by the different inverters 104. The ripple current vector 1600 may represent the ripple current generated by the first inverter, the ripple current vector 1602 may represent the ripple current generated by the second inverter, the ripple current vector 1604 may represent the ripple current generated by the third inverter, the ripple current vector 1606 may represent the ripple current generated by the fourth inverter, the ripple current vector 1608 may represent the ripple current generated by the fifth inverter, and the ripple current vector 1610 may represent the ripple current generated by the sixth inverter.

The individual ripple current vectors are added together with lengths of each of the individual ripple current vectors representing the magnitude (e.g., RMS) of the ripple current generated by the corresponding inverter. The directions of the individual ripple current vectors indicate or are based on (e.g., multiples of) the phase shifts between the switching cycles of the various inverters.

Similar to the vectors described above, the individual ripple current vectors for six times the switching frequency may be added together, with the individual ripple current vectors for the first through fourth inverters oriented relative to each other at the angles 1014 (shown in FIG. 10) that are six times the phase shift (e.g., 180 degrees). The individual ripple current vectors for the fifth and sixth inverters, however, are oriented relative to the individual ripple current vector for the fourth inverter at a different angle (e.g., an angle of six times forty-five degrees, or 270 degrees). This angle is six times the angle used for the fifth and sixth inverters at the switching frequency.

In contrast to the absence of a total ripple current vector shown in FIG. 14, there is a total ripple current vector 1612 in the example of FIG. 16. The starting location or point of the first individual ripple current vector and the ending location or point of the sixth (or last) individual ripple current vector are spaced apart from each other by a relatively large distance, indicating a larger total ripple current vector. As a result, there is a significant total ripple current vector at a frequency that is six times the switching frequency.

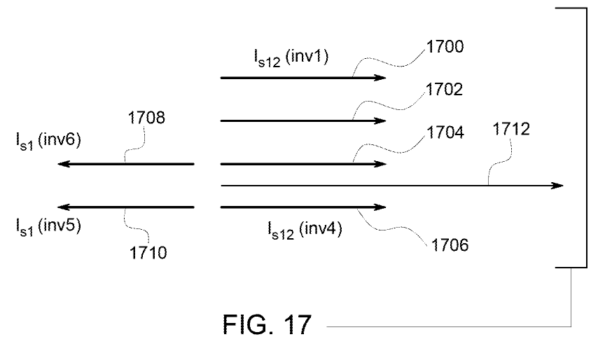

FIG. 17 illustrates individual ripple current vectors 1700, 1702, 1704, 1706, 1708, 1710 generated at twelve times the switching frequency (e.g., Iₛ₁₂) of the inverters 104 (shown in FIG. 1) according to one example. The individual ripple current vectors represent the ripple currents (or portions of the total ripple current) generated by the different inverters 104. The ripple current vector 1700 may represent the ripple current generated by the first inverter, the ripple current vector 1702 may represent the ripple current generated by the second inverter, the ripple current vector 1704 may represent the ripple current generated by the third inverter, the ripple current vector 1706 may represent the ripple current generated by the fourth inverter, the ripple current vector 1708 may represent the ripple current generated by the fifth inverter, and the ripple current vector 1710 may represent the ripple current generated by the sixth inverter.

The individual ripple current vectors are added together with lengths of each of the individual ripple current vectors representing the magnitude (e.g., RMS) of the ripple current generated by the corresponding inverter. The directions of the individual ripple current vectors indicate or are based on (e.g., multiples of) the phase shifts between the switching cycles of the various inverters.

Similar to the vectors described above, the individual ripple current vectors for twelve times the switching frequency may be added together, with the individual ripple current vectors for the first through fourth inverters oriented relative to each other at angles that are twelve times the phase shift (e.g., 360 degrees). The individual ripple current vectors for the fifth and sixth inverters, however, are oriented relative to the individual ripple current vector for the fourth inverter at a different angle (e.g., an angle of twelve times forty-five degrees, or 540 degrees).

Similar to the individual ripple current vectors shown in FIG. 16, there is a total ripple current vector 1712 in the example of FIG. 17. The starting location or point of the first individual ripple current vector and the ending location or point of the sixth (or last) individual ripple current vector are spaced apart from each other by a relatively large distance, indicating a larger total ripple current vector. As a result, there is a significant total ripple current vector at a frequency that is twelve times the switching frequency.

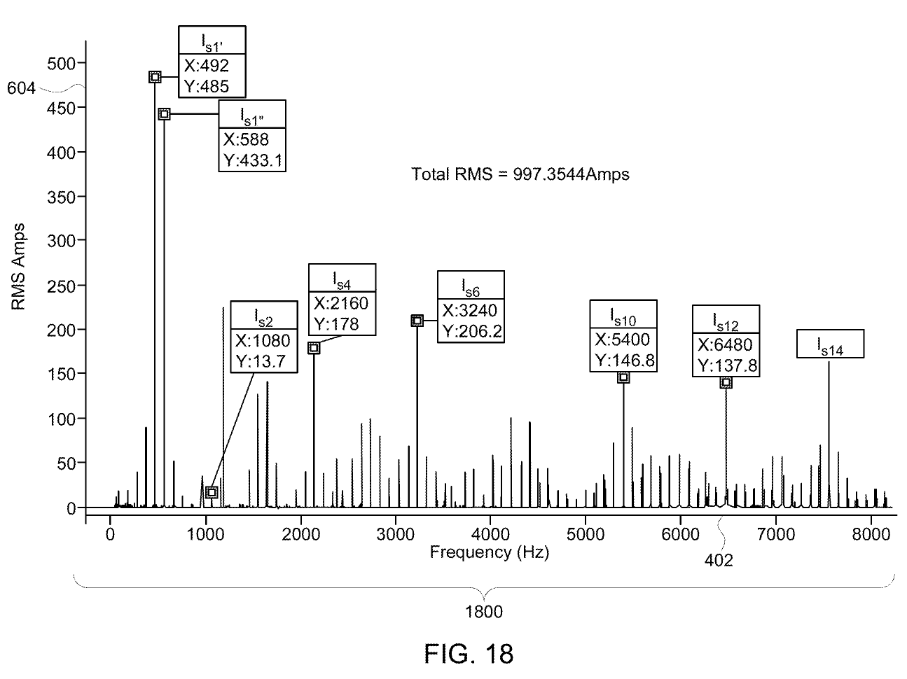

FIG. 18 illustrates one example an amplitude spectrum of currents 1800 conducted on the buses 112, 114 of the circuit 106 in the powered system 108 shown in FIG. 1. Similar to the current shown in FIGS. 4 and 6, the currents shown in FIG. 18 are shown alongside the horizontal axis 402 and the vertical axis 604 (described above in connection with FIGS. 4 and 6, respectively). In the illustrated example, the currents are generated when the switching frequencies of the inverters is 540 hertz with the current conducted from the inverters to the loads 116 (shown in FIG. 1) being 867 amperes. Alternatively, another switching frequency and/or load current may be used.

As shown by a comparison of the currents 600, 1800 shown in FIGS. 6 and 18, the magnitudes of the ripple currents conducted on the positive and negative DC buses are significantly reduced for some integer multiples of the switching frequency while the ripple currents are increased for other integer multiples of the switching frequency. Specifically, the ripple currents Iₛ₂, Iₛ₁₂ in FIG. 18 at frequencies that are twice and twelve times the switching frequency are reduced relative to the ripple currents at these same frequencies shown in FIG. 6. The ripple currents in FIG. 18 at other frequencies, however, are larger than the ripple currents at these same frequencies shown in FIG. 6 (e.g., the current Iₛ₄ at the frequency that is four times the switching frequency, the current Iₛ₆ that is six times the switching frequency, the current Iₛ₁₀ that is ten times the switching frequency, and the current Iₛ₁₄ that is fourteen times the switching frequency).

The examples of the ripple currents illustrated in FIGS. 6 and 18 indicate that the current control system shown in FIG. 1 can change the relative phase shifts between different pairs or groups of the inverters in order to control the frequencies at which the ripple currents are reduced. Some ripple current frequencies may have a larger or smaller negative impact on operation of the loads, and the control system may change or control the phase shifts of the switching cycles in the inverters to reduce the ripple currents at frequencies having a more negative impact on operation of the loads than at other frequencies.

The control system may vary the phase shifts between switching cycles of the inverters based on the number of inverters, the load currents output by the inverters, and/or the frequencies at which the ripple currents are to be reduced. With respect to the number of inverters and the frequencies at which the ripple currents are to be reduced, while the examples described above focus on use of six inverters, optionally, a different number of inverters may be used. The phase shift that can be used for the inverters to reduce or eliminate the total ripple current vector (e.g., more than other phase shifts) may be determined based on the following relationship:

$$ϕ = \frac{360}{2 * n} A$$

where φ represents the phase shift (expressed in degrees), n represents the number of inverters, and A represents the order of the switching frequency sought to be reduced. For example, if the ripple current at the second integer multiple of the switching frequency is to be reduced, then A has a value of two. If the ripple current at the sixth integer multiple of the switching frequency is to be reduced, then A has a value of six, and so on.

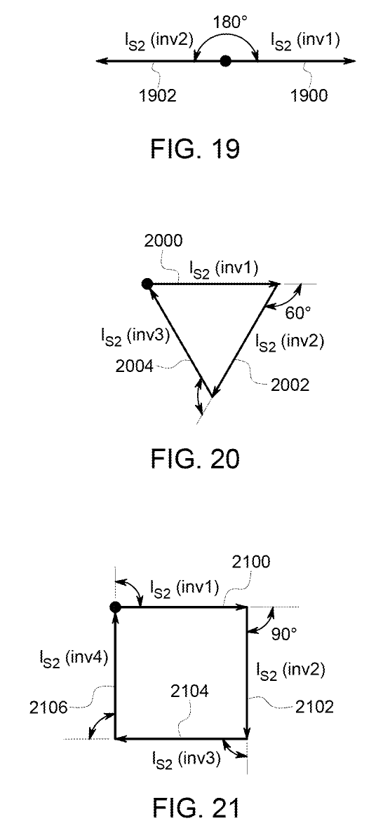

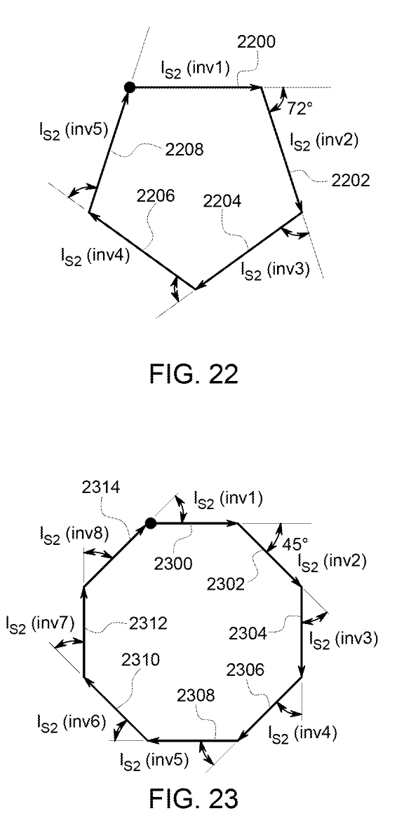

FIGS. 19 through 23 illustrate additional examples of phase shifts or angles that may be applied to the switching cycles of different numbers of inverters 104 connected to the same bus 112, 114 in FIG. 1 in order to reduce or eliminate the ripple currents at twice the switching frequencies of the inverters (e.g., the order or value of A is two). The angles shown in FIGS. 19 through 23 differ based at least in part on the number of inverters, and may be determined as the phase shifts described above, with individual ripple current vectors 1900, 1900 (FIG. 19), individual ripple current vectors 2000, 2002, 2004 (FIG. 20), individual ripple current vectors 2100, 2102, 2104, 2106 (FIG. 21), individual ripple current vectors 2200, 2202, 2204, 2206, 2208 (FIG. 22), and individual ripple current vectors 2300, 2302, 2304, 2306, 2308, 2310, 2312, 2314 (FIG. 23) representative of the ripple currents generated by each inverter in circuits having two (FIG. 19), three (FIG. 20), four (FIG. 21), five (FIG. 22), or eight (FIG. 23) inverters connected to the same bus. For example, the two inverter circuit can use phase shifts of 180 degrees (FIG. 19), the three inverter circuit can use phase shifts of sixty degrees (FIG. 20), the four inverter circuit can use phase shifts of ninety degrees (FIG. 21),

As shown in FIG. 19 through 23, the phase shifts for the second order frequencies are selected or determined to reduce or eliminate the total ripple current vector. The examples of FIGS. 19 through 23 involve the inverters each generating the same load current, which results in the individual ripple current vectors having the same length. Differences in the load currents generated by one or more of the inverters can result in the phase shifts being changed in order to cause the end of the ripple current vector for the last inverter to end at or near the beginning of the ripple current vector for the first inverter.

Optionally, the controller 102 may examine one or more operating conditions of the loads 116 in the circuit 106 and/or one or more operating conditions of the inverters 104 (shown in FIG. 1) in the circuit to determine (e.g., estimate, calculate, or obtain from previous measurements) the total ripple current that will be created in the circuit. The controller may then change the phase shifts between the switching cycles of the inverters based on the determined total ripple current to eliminate or reduce the total ripple current generated across all or a range of frequencies, or at or within a designated range of frequencies (e.g., twice the switching frequency, four times the switching frequency, etc.).

Magnitudes and/or phases of ripple currents created in the buses 112 and/or 114 of the circuit shown in FIG. 1 may be measured at different frequencies (e.g., at the switching frequency, at multiples of the switching frequency, etc.), at different modulation indices of the circuit, and at different power factors of the circuit. In one embodiment, the modulation indices of the circuit are ratios at which a modulated variable of the circuit (e.g., the voltage that alternates as the AC output by the inverters) varies with respect to an unmodulated level (e.g., the voltage that is input as the DC into the inverters). The modulation index of the circuit can be determined by the controller measuring how the voltages that are output from one or more inverters as AC varies with respect to the voltages that are input into the one or more inverters as DC (e.g., as measured by the inverter sensors).

The power factors of the circuit are ratios of the real power or active power conducted to the loads in the circuit to the apparent power conducted in the circuit shown in FIG. 1 in one embodiment. Lower power factors indicate that the circuit has greater current circulating in the circuit (instead of powering the loads) relative to greater power factors. The circuit may have a power factor of one when the voltage and current conducted in the circuit are in phase with each other. The power factor of the circuit may be zero when the current and the voltage are out of phase with respect to each other by ninety degrees. The controller may determine the power factor of the circuit by examining the voltages and currents measured by the ripple current sensor shown in FIG. 1 and determining the phase relationships of the voltages and currents.

The previous measurement of the ripple currents at different frequencies (e.g., using the ripple current sensor), at different modulation indices (e.g., using the inverter sensors that can measure the voltage input into the inverters and/or the voltage output by the inverters), and/or different power factors can allow for future ripple currents to be determined (e.g., estimated and/or calculated based on previous measurements under similar or identical operating conditions). Based on the ripple currents that are so determined, predicted, expected, or otherwise estimated, the controller can modify the switching cycles of one or more of the inverters in order to prevent these ripple currents from becoming too large (e.g., by preventing the ripple currents from being as large in magnitude as the estimated or calculated ripple currents) at one or more (or all) frequencies. As described above, the controller can change the phase shifts between the switching cycles of two or more of the inverters in order to reduce the total ripple current generated on the positive and/or negative DC bus and/or to reduce the ripple current generated at one or more frequencies.

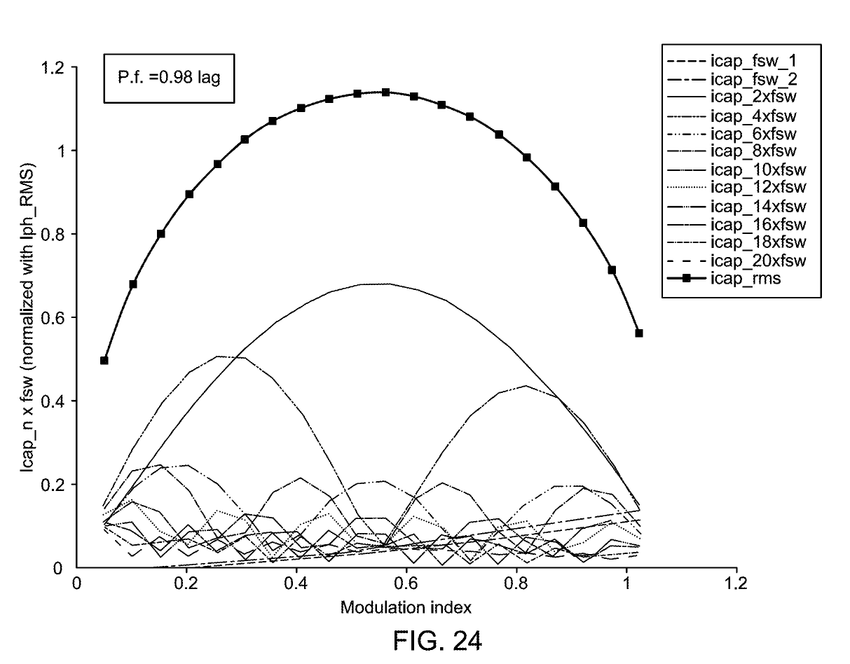

FIGS. 24 through 27 illustrate different sets of prospective ripple currents for different operating conditions of the circuit 106 in the powered system 108 shown in FIG. 1 according to one example. The ripple currents in each of FIGS. 24 through 27 are shown alongside a horizontal axis representative of modulation indices and a vertical axis representative of magnitudes of the ripple currents (e.g., values of the ripple current at the various switching frequencies normalized to a root mean square value of all of the ripple currents in the same set). In each of FIGS. 24 through 27, the ripple currents include a first ripple current icap_fsw_1 (representative of the expected ripple currents at a switching frequency of the inverters, such as 540 hertz minus a fundamental frequency of the loads being powered by the inverters, such as 16 hertz), a second ripple current icap_fsw_2 (representative of the expected ripple currents at the switching frequency of the inverters plus the fundamental frequency of the loads being powered by the inverters), a third ripple current icap_2×fsw (representative of the expected ripple currents at twice the switching frequency of the inverters), a fourth ripple current icap_4×fsw (representative of the expected ripple currents at four times the switching frequency of the inverters), a sixth ripple current icap_6×fsw (representative of the expected ripple currents at six times the switching frequency of the inverters), an eighth ripple current icap_8×fsw (representative of the expected ripple currents at eight times the switching frequency of the inverters), a tenth ripple current icap_10×fsw (representative of the expected ripple currents at ten times the switching frequency of the inverters), a twelfth ripple current icap_12×fsw (representative of the expected ripple currents at twelve times the switching frequency of the inverters), a fourteenth ripple current icap_14×fsw (representative of the expected ripple currents at fourteen times the switching frequency of the inverters), a sixteenth ripple current icap_16×fsw (representative of the expected ripple currents at sixteen times the switching frequency of the inverters), an eighteenth ripple current icap_18×fsw (representative of the expected ripple currents at eighteen times the switching frequency of the inverters), a twentieth ripple current icap_20×fsw (representative of the expected ripple currents at twenty times the switching frequency of the inverters), and a total ripple current icap_rms (representative of the root mean square value of all ripple currents at the same modulation index).

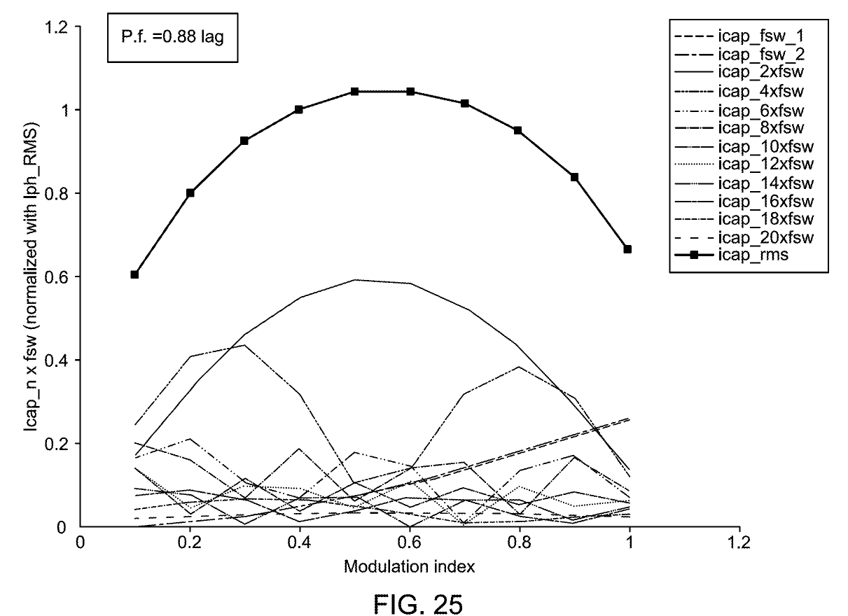

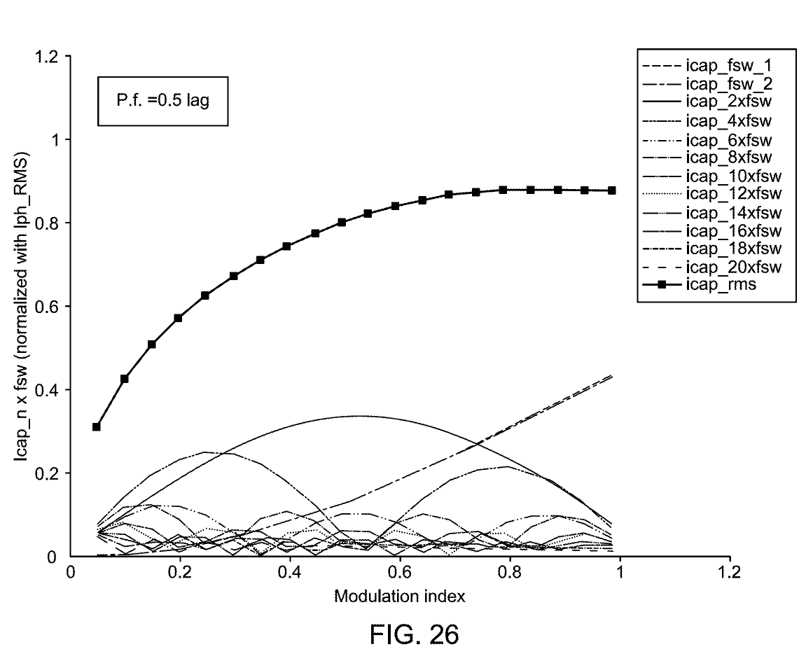

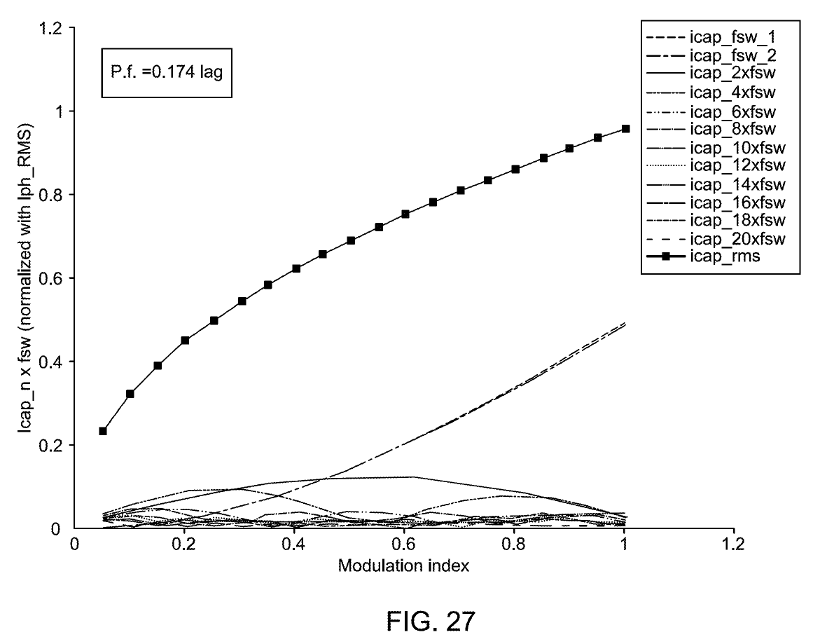

Each of FIGS. 24 through 27 illustrates a different set of the ripple currents, although more or fewer sets may be used to predict ripple currents at various operating conditions. Each of the sets of ripple currents is representative of different power factors of the circuit 106 shown in FIG. 1. For example, the ripple currents shown in FIG. 24 were previously measured or calculated for a power factor of 0.98 lag, which indicates a lagging power factor (e.g., the load is an inductive load) representative of a ratio of 0.98 of the real power or active power conducted to the loads in the circuit to the apparent power conducted in the circuit shown in FIG. 1. The ripple currents shown in FIG. 25 were previously measured or calculated for a lagging power factor of 0.88, and so on for FIGS. 26 and 27. The ripple currents may be measured or otherwise determined when the switching cycles of all inverters connected to the same bus are in phase.

The controller 102 in the control system 100 may predict the ripple currents that may or are likely to be created by the inverters 104 connected to the same bus 112, 114 by determining operating conditions of the circuit 106 that includes the inverters and the bus. The operating conditions may include the power factor of the circuit, which can be determined based on previous operation of the circuit in which the real or active power and the apparent power conducted in the circuit was calculated or measured (e.g., using one or more of the sensors 118, 122). The controller may obtain the set of ripple currents associated with the power factor that is determined (e.g., from an internal memory of the controller and/or a memory accessible to the controller, such as a tangible and non-transitory computer readable medium including, by way of example, a computer hard drive, optical disk, random access memory, read only memory, or the like). The controller may then determine the modulation index or indices at which the inverters are expected to operate (e.g., based on previous operation of the inverters in which the input and output voltages of the inverters were measured) and/or at which the inverters are operating (e.g., based on measurements of the voltages input and output by the inverters, as measured by one or more of the sensors). The controller may then examine the various expected ripple currents predicted to be generated at the value of the modulation index.

For example, if the controller determines that the operating conditions of the circuit indicate a lagging power factor of 0.88 and a modulation index of 0.3, then the controller can determine (from the set of ripple currents shown in FIG. 25), that the ripple currents at frequencies of twice and four times the switching frequency are predicted to be significantly larger than the ripple currents generated at other frequencies. The controller may use this information to determine the phase shifts between the different inverters in order to determine phase shifts that result in a reduction of the ripple currents at the frequencies that are twice and/or four times the switching frequency, as described above. For example, the controller may generate individual ripple current vectors representative of the magnitude of the ripple currents generated by each inverter (which can be based on previous measurements of the ripple currents generated by the various inverters under the same operating conditions as the set of ripple currents being examined) and can combine these vectors using different angles between the vectors. The set of angles that results in the individual ripple current vector for the last inverter (e.g., the sixth inverter shown in FIG. 1) being at or closer to the beginning of the individual ripple current vector for the first inverter (e.g., closer than one or more, or all, other sets of angles) may be selected by the controller. The selected angles may then be used to shift the phases of the switching cycles of the inverters.

For example, if the controller determines that an angle of thirty degrees between the individual ripple current vectors of the first and second inverters, an angle of thirty-five degrees between the individual ripple current vectors of the second and third inverters, an angle of twenty-seven degrees between the individual ripple current vectors of the third and fourth inverters, an angle of thirty-two degrees between the individual ripple current vectors of the fourth and fifth inverters, and an angle of forty degrees between the individual ripple current vectors of the fifth and sixth inverters results in a smaller or the smallest total ripple current vector for these individual ripple current vectors, then the controller may generate and communicate control signals to the inverters to shift the phases of the switching cycles of the inverters accordingly. A first control signal generated by the controller and communicated to the second inverter may direct the second inverter to shift (e.g., delay) the times at which the positive and negative switches 206, 208 in the legs 200, 202, 204 in the second inverter (shown in FIG. 2) switch between open and closed states be delayed by thirty degrees (e.g., delayed by 8.3% of the time period of a single switching cycle) relative to the first inverter. A second control signal generated by the controller and communicated to the third inverter may direct the third inverter to shift the times at which the positive and negative switches in the legs in the third inverter switch between states be delayed by thirty-five degrees (e.g., delayed by 9.72% of the time period of a single switching cycle) relative to the first inverter. Additional control signals may be generated by the controller and communicated to the inverters to shift the phases of the switching cycles of the inverters, accordingly.

The inverters may then operate using the various phase shifts instructed by the controller in order to reduce the ripple currents generated by the inverters at one or more frequencies (e.g., relative to not shifting the phases of the inverters). The controller may repeat the determination of the phase shifts to apply to one or more of the inverters responsive to operating conditions of the circuit or powered system changing. For example, responsive to the power factor changing, the controller may re-determine the prospective ripple currents using another, different set of the predicted ripple currents associated with the changed power factor. Responsive to the modulation index of the circuit in the powered system changing, the controller may determine whether the ripple currents at one or more other, different frequencies need to be reduced. The controller may repeat this determination on a periodic or on-demand basis (e.g., as requested by an operator of the powered system), and/or responsive to a change in the operating conditions of the powered system. With respect to the example provided above (where the operating conditions of the circuit indicate a lagging power factor of 0.88 and a modulation index of 0.3), the controller may change which frequency of ripple currents to reduce responsive to the power factor remaining the same but the modulation index increasing to 0.5 (e.g., by seeking to reduce the ripple currents at six times the switching frequency), or may change the frequency of ripple currents to reduce responsive to the power factor changing to a lagging power factor of 0.98 (with a modulation index of 0.4) to reduce the ripple currents at a frequency that is eight times the switching frequency).

The controller described herein can control the phase shifts between the switching cycles of the inverters for any number of inverters. For example, the controller may not be limited to controlling the phase shifts for only two inverters, but instead may use the techniques described herein for any number of two or more inverters, such as is shown in the examples of FIGS. 19 through 23. Additionally, the controller may vary the switching cycles of the inverters to cause the nulls in the switching cycles (e.g., the time periods when the voltage that is output as AC is at an upper or maximum value and the time periods when this voltage is at a lower or minimum value) for two or more inverters to overlap in time.

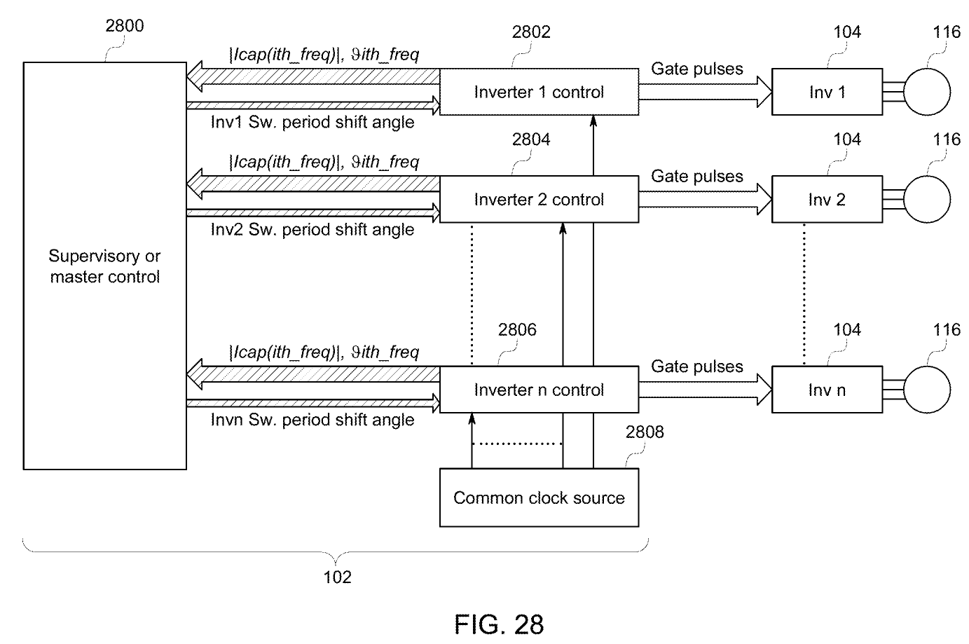

FIG. 28 illustrates one example of the controller 102 shown in FIG. 1. The controller may be formed from a supervisory or master control 2800 that is operably coupled with individual inverter controllers 2802, 2804, 2806 (“Inverter 1 Control”, “Inverter 2 Control”, and “Inverter n Control” in FIG. 28). Each of the inverter controllers is operably coupled with a different inverter 104, which are in turn connected with the loads 116 (as described above in connection with FIG. 1). The master control and the inverter controllers each can represent hardware circuitry that include and/or are connected with one or more processors (e.g., microprocessors, field programmable gate arrays, and/or integrated circuits) that perform the operations described herein. The master control and the inverter controllers may be operably coupled with each other (and/or with other components) via wired and/or wireless connections.

The master control can communicate with the sensors 118, 122 (shown in FIG. 1) to determine the operating conditions of the circuit 106 (shown in FIG. 1), as described above. The master control can receive signals provided by the sensors representative of the voltages and/or currents sensed by the sensors in order to determine the operating conditions. The individual inverter controllers optionally may communicate with the sensors, such as to determine the ripple currents created by the different inverters, and communicate these ripple currents to the master control (e.g., as |Icap(ith_freq|,θith_freq in FIG. 28). The master control can examine these ripple currents and determine the phase shifts to be applied to the switching cycles of one or more of the inverters, as described above. The phase shifts can be communicated to the individual inverter controllers (e.g., as Inv1 Sw. Period Shift Angle, Inv2 Sw. Period Shift Angle, and/or Invn Sw. Period Shift Angle in FIG. 28). The inverter controllers may receive the respective phase shifts and generate gate command signals (e.g., gate pulses in FIG. 28) to the respective inverters. The gate command signals or pulses instruct the positive and negative switches in the different inverters to open or close at the times corresponding to the switching cycle or phase-shifted switching cycles commanded by the master control. The individual inverter controllers and master control may communicate in a closed loop process to adapt and change the phase shifts of one or more inverters, as applicable, to reduce or eliminate one or more frequencies of the ripple currents generated by the inverters.

In one embodiment, the inverter controllers may be operably coupled (e.g., by one or more wired and/or wireless sensors) to a common clock device 2808 (“Common Clock source” in FIG. 28). The clock device represents a timekeeping device (e.g., a clock) that maintains and tracks a common time for the inverter controllers. The inverter controllers can communicate with the common clock device to ensure that the inverters operate on the same frame of reference with respect to time. These controllers can communicate with the clock device to ensure that the phase shifts determined by the master control are accurately implemented to cause the switching cycles of different inverters to be phase shifted by the correct amounts.

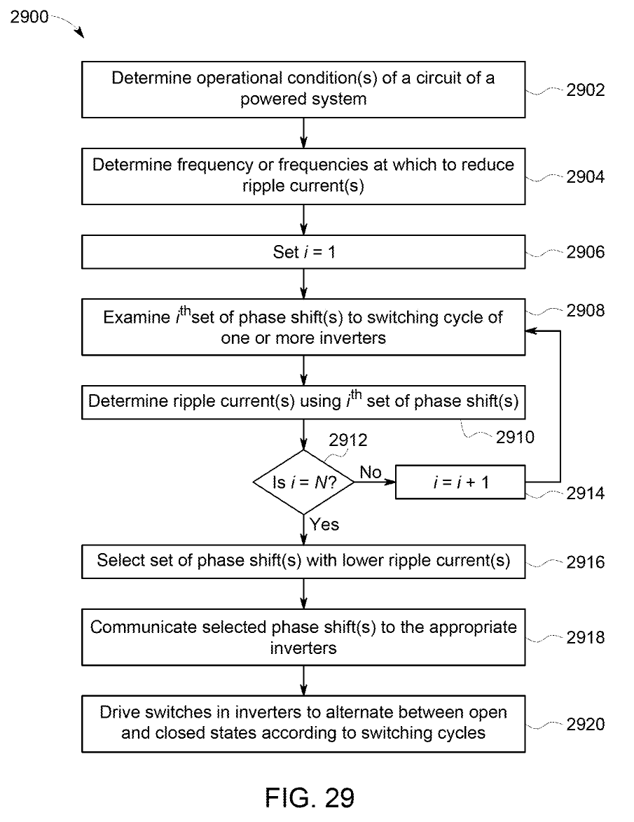

FIG. 29 illustrates a flowchart of one embodiment of a method 2900 for reducing ripple control current. The method 2900 may describe operation of the control system or may represent an algorithm useful for creating a software program for controlling operation of the control system described herein. At 2902, operational conditions of the circuit 106 of the powered system 108 are determined. These operational conditions can include power factors, modulation indices, ripple currents, or the like, as measured by one or more of the sensors 118, 122 or based on measurements obtained by the sensors. The measurements from the sensors may be communicated to the controller 102 (e.g., the master control 2800) in order for the controller 102 to calculate the operational conditions.

At 2904, a frequency or frequencies at which ripple currents conducted on the bus 112 and/or the bus 114 are to be reduced during operation of the circuit are determined. The frequency or frequencies may be determined based on input provided by an operator. For example, an operator may communicate a signal to the controller (e.g., the master control) via one or more input devices (e.g., keyboards, touchscreens, buttons, etc.) that indicates which frequency or frequencies of ripple currents are to be reduced. Optionally, the controller may be programmed with a default frequency or default frequencies at which to reduce the ripple currents. In one embodiment, the controller (e.g., the master control) may examine operational conditions of the circuit or powered system to identify which frequencies of the ripple currents are predicted to be larger than one or more (or all) other frequencies, as described above. These frequencies with the larger or largest predicted ripple currents may be selected at 2904.

At 2906, a value of a variable i is set to a default starting value, such as one. This variable is used to represent different sets of phase shifts that are examined for reducing or eliminating one or more frequencies of ripple currents, as described below. At 2908, an i^{th} set of phase shifts to the switching cycle of one or more inverters is examined to predict the ripple currents that are likely to be generated. As described above, different angles (e.g., phase shifts) between individual ripple current vectors may be used in adding the individual ripple current vectors. This portion of the method 2900 can iteratively attempt or examine different combinations of these angles (e.g., phase shifts) to try and determine which set of angles (e.g., phase shifts) results in smaller total ripple currents, the smallest total ripple current, or an elimination of the ripple current at one or more frequencies relative to one or more other, different sets of angles (e.g., phase shifts).

At 2910, the ripple current or currents that will be generated using the i^{th} set of angles or phase shifts are determined. For example, the master control may predict the magnitude of the ripple currents generated at one or more frequencies when the switching cycle of one or more of the inverters is shifted by the phase shifts in the i^{th} set. The total ripple current may be predicted as described above.

At 2912, a determination is made as to whether the current value of the variable i is equal to a value of N, which represents a total number of sets of angles or phase shifts to be examined. For example, there may be N total permutations or combinations of phase shifts that may be applied to the switching cycles of the inverters. This determination checks to see if all N of these permutations or combinations have been examined at 2910 to determine potential ripple currents.

If the value of i is not yet equal to N, then there may be additional different phase shifts to be examined. As a result, the value of i may be changed, signifying that another set of different phase shifts are to be examined. Flow of the method 2900 may proceed toward 2914, where the value of i is changed. The method 2900 may then return to 2908 to examine the impact of the next set of phase shifts under examination on the predicted ripple currents.

If, on the other hand, the value of i is equal to N, then there may not be additional different phase shifts to be examined. As a result, flow of the method 2900 may proceed toward 2916. At 2916, a set of phase shift(s) is selected. The set of phase shifts that is selected may be those phase shifts examined at 2910 that resulted in the ripple current(s) at the selected frequency or frequencies being eliminated or lower than the ripple currents for one or more (or all) other sets of phase shifts.

At 2918, the phase shifts in the selected set are communicated to the inverters. For example, the master control may instruct the individual inverter controllers as to the phase shift to be applied to the respective inverter. At 2920, the switches in the inverters are controlled to alternate between open and closed states at times that correspond to the switching cycles of the inverters, as shifted in time by the selected phase shifts. The individual controllers can communicate gate signals or pulses to the switches to direct the switches to open or close at the times dictated by the switching cycles (and phase shifts, where applicable).

In one embodiment, a ripple current control system includes plural inverters connected to a common bus. The inverters are configured to convert a direct current (DC) through the common bus to an alternating current (AC) by alternating different switches of the inverters between open and closed states in a switching cycle for each of the inverters. The system also includes a controller configured to reduce a ripple current conducted onto the common bus by controlling the inverters to apply a phase shift to the switching cycle of one or more of the inverters based on the number of the inverters.

In one example, the controller is configured to determine the phase shift based on the number of inverters by determining the phase shift between ripple current vectors of the inverters that results in reducing or eliminating a difference between a beginning of a first ripple current vector of the vectors and an end of a last ripple current vector of the vectors.

In one example, the controller is configured to apply different phase shifts to the switching cycles of two or more of the inverters.

In one example, the controller is configured to predict potential ripple currents that would be generated by the inverters and conducted on the common bus based on one or more operating conditions of a circuit that includes the common bus and the inverters.

In one example, the one or more operating conditions include a power factor of the circuit.

In one example, the one or more operating conditions include a modulation index of the circuit.

In one example, the controller is configured to change the phase shift that is applied to the switching cycle of the one or more inverters during operation of the inverters in response to a change in the one or more operating conditions of the circuit.

In one example, the controller is configured to select one or more frequencies at which to reduce the ripple currents and to select the phase shift to be applied to the switching cycle of the one or more inverters based on the one or more frequencies that are selected.

In one example, the inverters include three or more inverters.

In one embodiment, another ripple current control system includes plural inverter controllers configured to be operably coupled with plural inverters connected to a common bus. The inverters are configured to convert a direct current (DC) through the common bus to an alternating current (AC) by alternating different switches of the inverters between open and closed states in a switching cycle for each of the inverters. The system also includes a master controller configured to be operably coupled with the inverter controllers. The master controller is configured to predict a ripple current conducted onto the common bus from the inverters, and to reduce a ripple current that is conducted onto the common bus relative to the ripple current that is predicted by changing the switching cycle of one or more of the inverters.

In one example, the master controller is configured to change the switching cycle of the one or more inverters by applying a phase shift to the switching cycle.

In one example, the master controller is configured to determine the phase shift based on a number of the inverters connected to the common bus.

In one example, the master controller is configured to determine the phase shift based on one or more frequencies at which the ripple current that is predicted is to be reduced.

In one example, the controller is configured to predict the ripple current that would be generated by the inverters and conducted on the common bus based on one or more operating conditions of a circuit that includes the common bus and the inverters.

In one example, the one or more operating conditions include a power factor of the circuit.

In one example, the one or more operating conditions include a modulation index of the circuit.

In one example, the controller is configured to change a phase shift that is applied to the switching cycle of the one or more inverters during operation of the inverters in response to a change in the one or more operating conditions of the circuit.

In one example, the controller is configured to select one or more frequencies at which to reduce the ripple currents and to select a phase shift to be applied to the switching cycle of the one or more inverters based on the one or more frequencies that are selected.

In one embodiment, a method for controlling ripple currents includes determining a number of inverters connected to a common bus. The inverters are configured to convert a direct current (DC) through the common bus to an alternating current (AC) by alternating different switches of the inverters between open and closed states in a switching cycle for each of the inverters. The method also includes determining a phase shift to the switching cycle of one or more of the inverters, the phase shift determined based on the number of inverters, and reducing or eliminating a ripple current conducted onto the common bus by controlling the inverters to apply the phase shift to the switching cycle of one or more of the inverters.

In one example, the method also includes predicting one or more potential ripple currents that would be generated by the inverters and conducted on the common bus based on one or more operating conditions of a circuit that includes the common bus and the inverters. The phase shift can be determined based on the one or more potential ripple currents that are predicted.

In one example, the one or more operating conditions include one or more of a power factor of the circuit or a modulation index of the circuit.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

The above description is illustrative and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Other embodiments may be apparent to one of ordinary skill in the art upon reviewing the above description. The scope of the inventive subject matter should, therefore, be determined with reference to the appended claims, along with the full scope of equivalents to which such claims are entitled.

In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure. And, as used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising:
plural inverters connected to a common bus, the inverters configured to convert a direct current (DC) through the common bus to an alternating current (AC) by alternating different switches of the inverters between open and closed states in a respective switching cycle for each of the inverters; and
a controller configured to reduce a ripple current conducted onto the common bus by controlling the inverters to apply a phase shift to the switching cycle of one or more of the inverters based on the number of the inverters.

2. The system of claim 1, wherein the controller is configured to apply different phase shifts to the switching cycles of two or more of the inverters.

3. The system of claim 1, wherein the controller is configured to predict potential ripple currents generated by the inverters and conducted on the common bus based on one or more operating conditions of a circuit that includes the common bus and the inverters.

4. The system of claim 3, wherein the one or more operating conditions include a power factor of the circuit.

5. The system of claim 3, wherein the one or more operating conditions include a modulation index of the circuit.

6. The system of claim 3, wherein the controller is configured to change the phase shift that is applied to the switching cycle of the one or more inverters during operation of the inverters in response to a change in the one or more operating conditions of the circuit.

7. The system of claim 1, wherein the controller is configured to select one or more frequencies at which to reduce the ripple currents and to select the phase shift to be applied to the switching cycle of the one or more inverters based on the one or more frequencies that are selected.

8. The system of claim 1, wherein the inverters include three or more inverters.

9. The system of claim 1, wherein the controller is configured to determine the phase shift based on the number of inverters by determining the phase shift between ripple current vectors of the inverters that results in reducing or eliminating a difference between a beginning of a first ripple current vector of the vectors and an end of a last ripple current vector of the vectors.

10. A system comprising:
plural inverter controllers configured to be operably coupled with plural inverters connected to a common bus, the inverters configured to convert a direct current (DC) through the common bus to an alternating current (AC) by alternating different switches of the inverters between open and closed states in a respective switching cycle for each of the inverters; and
a master controller configured to be operably coupled with the inverter controllers, the master controller configured to predict a ripple current conducted onto the common bus from the inverters, the master controller also configured to reduce a ripple current that is conducted onto the common bus relative to the ripple current that is predicted by changing the switching cycle of one or more of the inverters.

11. The system of claim 10, wherein the master controller is configured to change the switching cycle of the one or more inverters, to reduce the ripple current that is conducted onto the common bus, by applying a phase shift to the switching cycle.

12. The system of claim 11, wherein the master controller is configured to determine the phase shift based on a number of the inverters connected to the common bus.

13. The system of claim 11, wherein the master controller is configured to determine the phase shift based on one or more frequencies at which the ripple current that is predicted is to be reduced.

14. The system of claim 10, wherein the master controller is configured to predict the ripple current that would be generated by the inverters and conducted on the common bus based on one or more operating conditions of a circuit that includes the common bus and the inverters.

15. The system of claim 14, wherein the one or more operating conditions include a power factor of the circuit.

16. The system of claim 14, wherein the one or more operating conditions include a modulation index of the circuit.

17. The system of claim 14, wherein the master controller is configured to change a phase shift that is applied to the switching cycle of the one or more inverters during operation of the inverters in response to a change in the one or more operating conditions of the circuit.

18. The system of claim 10, wherein the master controller is configured to select one or more frequencies at which to reduce the ripple currents and to select a phase shift to be applied to the switching cycle of the one or more inverters, to reduce the ripple current that is conducted onto the common bus, based on the one or more frequencies that are selected.

19. A method comprising:
determining a number of inverters connected to a common bus, the inverters configured to convert a direct current (DC) through the common bus to an alternating current (AC) by alternating different switches of the inverters between open and closed states in a respective switching cycle for each of the inverters;
determining a phase shift to the switching cycle of one or more of the inverters, the phase shift determined based on the number of inverters; and
reducing or eliminating a ripple current conducted onto the common bus by controlling the inverters to apply the phase shift to the switching cycle of one or more of the inverters.

20. The method of claim 19, further comprising predicting one or more potential ripple currents that would be generated by the inverters and conducted on the common bus based on one or more operating conditions of a circuit that includes the common bus and the inverters, wherein the phase shift is determined based on the one or more potential ripple currents that are predicted.

21. The method of claim 20, wherein the one or more operating conditions include one or more of a power factor of the circuit or a modulation index of the circuit.
